(19) United States
(12) Patent Application Publication
(10) Pub. No.: US 2025/0342755 A1
(43) Pub. Date: Nov. 6, 2025

(54) DEVICES, SYSTEMS, AND METHODS FOR PROVIDING GS1 DATA DRIVEN ACTIONS IN A LABEL SCANNER

(71) Applicant: Datalogic USA, Inc., Eugene, OR (US)

(72) Inventors: Jonathan R. BRANDT, Eugene, OR (US); Michele BENEDETTI, Lippo di Calderara di Reno (Bologna) (IT); Matthew MONTE, Eugene, OR (US); Mohamed HAMIDAT, Les Ulis (FR)

(21) Appl. No.: 19/199,245

(22) Filed: May 5, 2025

Related U.S. Application Data
(60) Provisional application No. 63/642,528, filed on May 3, 2024.

(51) Int. Cl. G07G 1/00; G06F 9/451; G06K 7/14

(52) U.S. Cl. CPC G07G 1/0045; G06F 9/451; G06K 7/1408

(57) ABSTRACT

An image-based optical scanner utilizes methods to provide unique actions, such as notifications or other indications for specific results of checks on GS1 label application data. A scanning device may include an imager configured to capture images of items passing through a field of view, a memory having rules stored thereon associated with actions to be taken based on decoded GS1 label application data, and a processor operably coupled to the imager and the memory, the processor configured to generate unique actions for specific results of checks on GS1 label application data decoded from a GS1 Digital Link label on the item.

### RELATED APPLICATIONS

This application claims the benefit of U.S. Provisional Application No. 63/642,528, filed May 3, 2024, and entitled “Devices, Systems, and Methods for Providing GS1 Data Driven Actions in a Label Scanner,” the disclosure of which is incorporated by reference herein in its entirety.

### CROSS-REFERENCE TO RELATED APPLICATIONS

This application is related to U.S. Provisional Application No. 63/642,524, filed May 3, 2024, and entitled “Devices, Systems, and Methods for Improving Throughput of Scanners Capturing Images of Items Potentially Having Multiple Labels,” and its corresponding non-provisional application filed on the same day of the present application. The disclosure of each of these applications is incorporated by reference herein in their entirety.

### TECHNICAL FIELD

The present disclosure generally relates to optical scanning devices and, more particularly, to capturing and processing of images containing subject matter of interest such as of items having multiple labels disposed thereon, such as machine-readable symbols or patterns.

### BACKGROUND

Image-based optical scanning includes a diverse range of applications such as reading of machine-readable symbols (e.g., one-dimensional symbols, 2-dimensional symbols), optical character recognition, object detection or recognition, and the like. In general, such systems work by capturing a digital image of a subject using a camera with an image sensor, and computationally processing the captured image to autonomously detect, recognize, or read the subject. The output generally includes data represented by, or describing, the subject. For example, in the case of reading a 1D or 2D symbol, the output may be a number or an alphanumeric string represented by that symbol. Likewise, in the case of recognizing a printed or hand-written character or set of characters, the output may be a textual representation of that character or set; and in the case of object recognition, the output may be a classification result (e.g., a label) describing the object. Optical scanners offer the versatility of being able to capture many different types of symbols and at different distances from the reader. State-of-the-art optical scanners use multiple cameras with different fields of view to capture multiple images of the subject, and use image processing techniques to determine the best image for symbol reading.

GS1 Digital Link is an important part of the retail industry's global migration to 2D barcodes where the vision is that each product will have a single multipurpose 2D barcode that can be used at the retail point-of-sale, and to access digital content such as certifications, instructions for use, product information, traceability information and more. During a transitional period, some products may include a set of labels being present including, for example, a ID label (e.g., linear barcode) and a 2D label (e.g., QR code).

Once customers start using the 2D label information of the GS1 Digital Link label set, it is expected that they will want the 2D label information if it is printed on an item. Some items will only have a linear label and some items will have both the linear and 2D labels and/or other label schemes (e.g., digital watermarks). After the GS1 Digital Link transitional period time is over, it is expected that items will have only a linear label or a 2D label with or some other label scheme. The inventors have contemplated solutions that address problems that may be encountered during this transitional period, which may be improved upon with enhanced features to improve the user experience.

In one example setting, recalls of items put into the market may occur when the manufacturer finds such items can present a health risk and need to be removed from market. Typically, a notice is sent to the distributors/retailers to remove from sales of such products, but in reality this information is not well managed. This can be due to limited resources dedicated to this task, and the facts that all items of a specific lot are not easy to localize (can be on shelves, at warehouses, different locations, etc.) The inventors have contemplated solutions that improve the operation of the scanner to address such situations, and others, to improve the checkout and customer experience.

### BRIEF SUMMARY

A scanning device may include an imager configured to capture images of items passing through a field of view, a memory having rules stored thereon associated with actions to be taken based on decoded GS1 label application data, and a processor operably coupled to the imager and the memory, the processor configured to generate unique actions for specific results of checks on GS1 label application data decoded from a GS1 Digital Link label on the item.

### BRIEF DESCRIPTION OF THE DRAWINGS

FIG. 1 is a simplified schematic block diagram of a scanning device according to an embodiment of the disclosure.

FIG. 2 is a scanning system configured for providing GS1 label data-driven actions according to embodiments of the disclosure.

FIG. 3 is a simplified block diagram of the scanning system configured for providing GS1 label data-driven actions according to embodiments of the disclosure.

FIGS. 4 and 5 show an example of a pop-up window displaying the alert over the POS application GUI.

### DETAILED DESCRIPTION

The illustrations included herewith are not meant to be actual views of any particular systems, memory device, architecture, or process, but are merely idealized representations that are employed to describe embodiments herein. Elements and features common between figures may retain the same numerical designation except that, for ease of following the description, for the most part, reference numerals begin with the number of the drawing on which the elements are introduced or most fully described. In addition, the elements illustrated in the figures are schematic in nature, and many details regarding the physical layout and construction of a memory array and/or all steps necessary to access data may not be described as they would be understood by those of ordinary skill in the art.

As used herein, the singular forms “a,” “an,” and “the” are intended to include the plural forms as well, unless the context clearly indicates otherwise.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “coupled to” or “coupled with” refer to structures operatively connected with each other, such as connected through a direct connection or through an indirect connection (e.g., via another structure or component).

As used herein, terms such as “scanning device,” “scanner,” “reader,” may be used interchangeably for devices that are configured to capture images of items and recognize (i.e., read) machine-readable symbols such as barcodes (1D, 2D, etc.) or other related symbologies.

A global trade identification number (GTIN) may be an identifier of an item, such as, for example, a 14 digit number that is specified by the GS1 organization.

Embodiments of the disclosure may be incorporated into a variety of scanning devices having different form factors and configurations, such as fixed retail scanners (e.g., single plane scanners, bi-optic scanners, presentation scanners, etc.), handheld scanners, mobile computers, wearable scanners, industrial scanners, scan engines, etc. that are used in a variety of applications and settings. Examples of various configurations and components of such scanners are described in U.S. patent Ser. No. 18/071,594, filed Nov. 29, 2022, and entitled “FIXED RETAIL SCANNER WITH MULTI-PORT NETWORK SWITCH AND RELATED METHODS,” U.S. Pat. No. 11,048,301, issued Jun. 29, 2021, entitled “MULTIPLE DISPLAYS MANAGEMENT IN BARCODE READING APPLICATIONS,” U.S. Pat. No. 11,227,173, issued Jan. 18, 2022, entitled “VIRTUAL-FRAME PREPROCESSING FOR OPTICAL SCANNING,” U.S. Pat. No. 11,416,697, issued Aug. 16, 2022, entitled “INDUCTIVE AIMING TRIGGER,” and U.S. Pat. No. 11,954,556, issued Apr. 9, 2024, entitled “WEARABLE GLOVE WITH AUTO RECOGNITION,” the disclosure of each of which is incorporated by reference in their entirety. Different components, configurations, and form factors of various scanning devices are also contemplated including combinations of those described herein.

Embodiments of the disclosure may include a scanner being configured to provide customizable feedback responsive to the reading of specific data fields specified in the GS1 standard. Examples of data fields are expiration date, serial number, and the like. Configurable logic within the scanner may be used to connect the specific data field to the configured action.

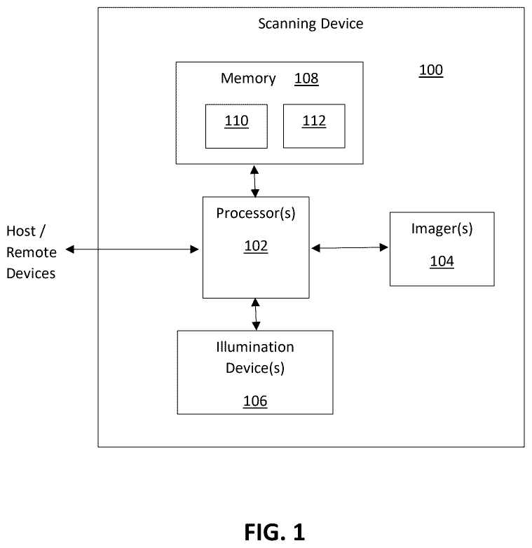

FIG. 1 is a simplified schematic block diagram of a scanning device 100 according to an embodiment of the disclosure. The scanning device includes one or more processors 102 operably coupled to one or more imagers 104, illumination devices 106, and memory 108. Memory 108 may be a separate memory device, embedded memory (e.g., embedded with the system processor) or both (e.g., distributed memory) that may include volatile and/or non-volatile memory to store instructions and/or data, that when executed by the or more processors 102, performs the functionality and methods of operating the scanning device 100 described herein.

The processor 102 may be configured to control operation (e.g., trigger, synchronization, etc.) of the imagers 104 and illumination devices 106. The processor 102 may also be configured to execute decoding algorithms configured to decode machine-readable symbols (i.e., labels) located within the images captured by the imagers 104. The processor 102 may include one processor or multiple processors configured to perform different tasks of the system. The memory 108 may include a GTIN database 112 that may include associations related to the multiple labels that may be present on various items. The GTIN database 112 may include label data associated with 1D or 2D labels, with the label data being different than the GTIN.

The scanning device 100 may be configured such that the processor 102 executes instructions, that cause the scanning device 100 to perform various operations. Embodiments of the disclosure includes label data (e.g., GS1 label data), besides the typical GTIN data, to be decoded by label scanners with retail systems and other systems in the world. The label data may include data such as expiration dates, lot numbers, serial numbers, best-by dates, production date, among other contemplated production and retail data. The scanning device 100 may be configured to parse the GS1 label data and perform actions (e.g., indications) based on the label data. The scanning device 100 may be configured to notify the user of an expired product, a product that has been recalled, and/or other data-driven indications.

The rules 110 (e.g., instructions or associations) executed by the processor 102 to trigger the actions may be enabled through a general configuration scheme that is loaded (e.g., in memory 108) in the scanning device 100 and/or programmed by a user. In some embodiments, certain specific notification features (e.g., expired products) may be turned on and off with a configuration property that is loaded in the scanning device 108 and/or programmed by a user. In addition, in some embodiments a scripting language may be provided for the processor 102 that is used to parse such label data and generate a specified indication in response thereto. The scripting language may be provided with the ability to determine the current time, which may be used to verify the date-based label data (e.g., expiration date, best buy date, etc.).

The scanning device 100 may, therefore, screen (via the processor 102 on the scanner 100 itself) for expired products, product recalls, or other data without changing the configuration of the POS system. When the scanning device 100 determined that an item meets screening parameter (e.g., expired product, product recall, etc.), the scanning device 100 may generate a notification the user through a specified action. This screening may occur by combining the GTIN value (e.g., EAN/UPC barcode) with additional information (e.g., batch/item number, expiry date, etc.) Thus, the scanning device 100 itself may be configured to automatically provide a control mechanism for retail transactions without involving the POS application or human resources by verifying in real time GTIN data and other application identifier information for the product.

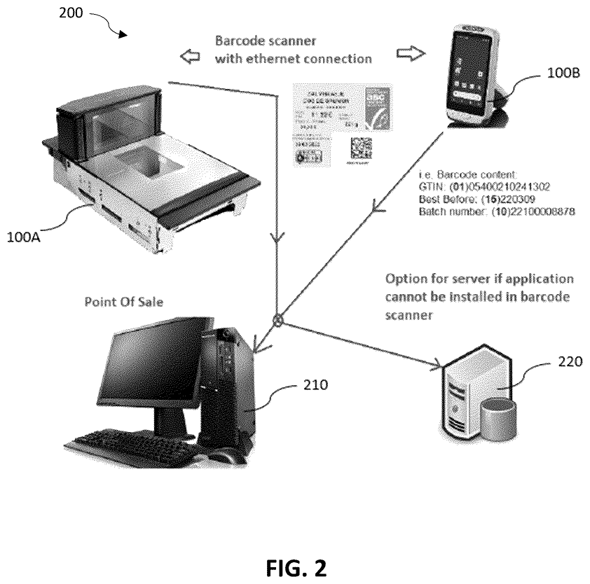

FIG. 2 is a scanning system 200 configured for providing GS1 label data-driven actions according to embodiments of the disclosure. The scanning system 200 may include one or more scanning devices 100A, 100B that may be connected to a point-of-sale (POS) system 210 at a retail checkout location (e.g., assisted checkout, self-checkout, etc.). In some embodiments, the scanning devices 100A, 100B and/or the POS system 210 may be connected to a remote server 220, such as an in-store server at the retail location or at a remote location (e.g., cloud). The scanning devices 100A, 100B may be configured as the scanning device 100 of FIG. 1 that may have different form factors, such as an in-counter fixed retail scanner (e.g., scanner 100A) or a mobile scanner (e.g., scanner 100B) that may be handheld, wearable, etc. Other form factors, such as presentations scanners that rest on a counter or may be fixed to a surface, wearable scanners, smart phones, or scan engines that are incorporated into various devices or POS arrangements (e.g., kiosks, price checking stations, etc.) are also contemplated.

The scanning devices 100A, 100B may be configured to capture images and decode one or more barcodes to determine a GTIN for the product from a first label (e.g., 1D barcode) as well as to determine additional product information from a second label (e.g., 2D barcode). The GTIN may be transmitted (e.g., over an Ethernet connection or other communication protocol or network) to the POS system 210 for the item to be added to the transaction. The additional product information may include information such as an expiration date, a batch/lot number to be checked by the scanner 100A, 100B itself and/or the POS system 210 and perform GS1 label data-driven actions in response thereto. When such analysis is performed by the scanner 110A, 100B itself, additional commands may be transmitted to the POS system 210 to take an appropriate action (e.g., notification, alert, suspension of transaction, etc.). In some embodiments, the additional product information may be transmitted with the GTIN data to the POS system 210 and/or the server 220 to perform the additional analysis based on the additional product information. For example, the additional product information (e.g., batch/lot) may be compared to up-to-date databases of recalled items to determine if the item has been recalled. Such recall databases may be periodically updated as information about recalled items are published. The updates may be performed via a service (e.g., API) and/or manually by a retailer. In some embodiments, the additional product information (e.g., expiration date) may be compared to a current date maintained by the scanner 100A, 100B and/or the POS system 210 to determine if the item has expired. As a result, retailers can avoid selling recalled or expired products.

In some embodiments, the scanner (e.g., 100B) may be connected to an inventory management system such that products are scanned at arrival or at other stages of inventory management to identify such recalled or expired products before being placed on shelves or sold.

Various application identifiers may be applicable to embodiments of the disclosure. Some of the more common application identifiers that may be used in retail environments are described in the following table:

| AI | Description | Format |
|---|---|---|
| 01 | Global Trade Item Number (GTIN) | N2 + N14 |
| 10 | Batch or lot number | N2 + X . . . 20 |
| 11 | Production date (YYMMDD) | N2 + N6 |
| 15 | Best before date (YYMMDD) | N2 + N6 |
| 16 | Sell by date (YYMMDD) | N2 + N6 |
| 17 | Expiration date (YYMMDD) | N2 + N6 |
| 21 | Serial number | N2 + X . . . 20 |

Application identifier data may be used by the scanning device 100 to perform a specified action. Examples of such situations may include:
a. AI 01—GTIN: A unique action may be performed by the scanning device 100 when a specific product is scanned to remind the user of a special action that is needed.
b. AI 10—Batch or lot number: A unique action may be performed by the scanning device 100 when a specific batch or lot number of a specific product is scanned to identify a recalled item.
c. AI 17—Expiration date: A unique action may be performed by the scanning device 100 when a product is scanned on or after the expiration date to prevent the item from being sold or cause the product to be sold at a reduced price. Also, a unique action may be performed by the scanning device 100 when a product is scanned within a timeframe of the expiration date to indicate the product should be sold at a reduced in price.
d. AI 21—Serial number: A unique action may be performed by the scanning device 100 when a specific serial number or range of serial numbers is scanned to identify a recalled item.

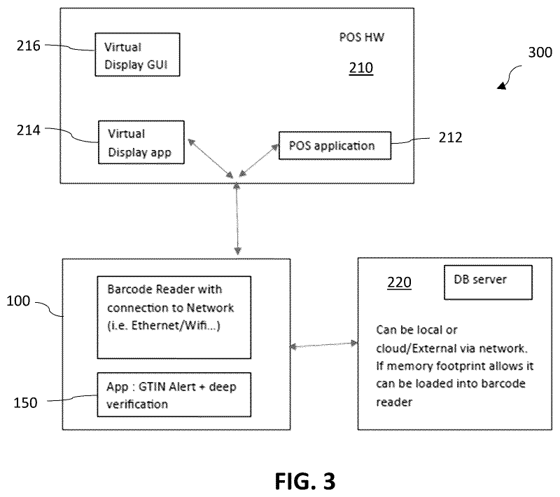

FIG. 3 is a simplified block diagram of the scanning system 300 configured for providing GS1 label data-driven actions according to embodiments of the disclosure. The scanning system 300 may include the POS system 210, the scanning device 100, and the server 220. The POS system 210 may be configured with a POS application 212, a virtual display application 214, and a virtual display GUI 216. The virtual display application 214 may be developed in a language that can support multi-platforms/OSs (e.g., Java, Windows/Linux, etc.), which can be loaded onto the POS 210 hardware to display a specific message (e.g., alert) for the end user (e.g., cashier, customer, etc.). The virtual display application 214 may be independent of the POS application 212 and will capture the data sent by the scanning device 100. In some embodiments, the virtual display application 214 and the POS application 212 may be hosted on separate devices, such as the virtual display application 214 hosted a fixed retail scanner (e.g., bioptic scanner, single plane scanner, etc.), a mobile computer, a handheld scanner, a presentation scanner, and the like, while the POS application 212 may be hosted on a POS system hardware, such as a desktop computer or other POS device. In some embodiments, the virtual display application 214 and the POS application 212 may be hosted on the same device. In some embodiments, the same device may include a scanner that hosts both the virtual display application 214 and the POS application 212 with the response thereto being communicated to the POS system 210 for taking actions described herein. In some embodiments, a fully integrated device (e.g., kiosk) may be configured to perform all disclosed functions.

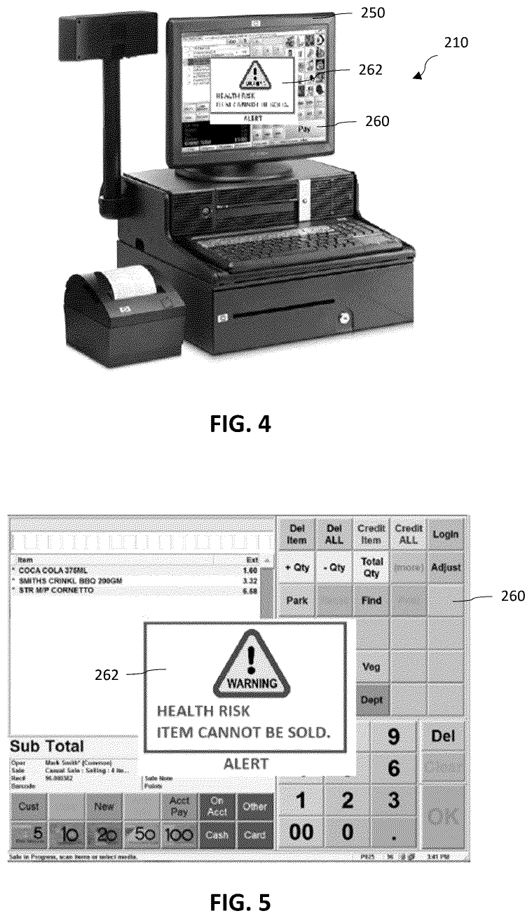

In operation, the scanning device 100 may capture and decode barcode information to determine a GTIN for the product (e.g., from a first barcode label), as well as additional product information (e.g., from a second barcode label). The GTIN may be provided to the POS application 212 (not the virtual display application 214) of the POS system 210 for adding the item to a transaction. In addition, the scanning device 100 may detect an alert situation based on the additional product information retrieved from a product label. For example, the additional information may include an expiration date, a batch/lot number, and the like to determine that the product that has expired, the product has been recalled or subject to some other health determination, or some other determination from analyzing the additional product information. In some embodiments, the additional product information may include allergen information that is compared to a customer profile to determine that a health warning is warranted in this situation. The scanning device 100 may then transmit a command (e.g., alert) to the virtual display application 214 (not the POS application 212) of the POS system 210 or provide another indication (e.g., email/text alert to manager, audible or visual alerts) to pause a transaction or provide other interventions. The virtual display application 214 may trigger a virtual display GUI 216 (e.g., as a pop-up window 262) that is automatically displayed over the POS application GUI 260 displayed on the display screen 250 of the POS system 210. FIGS. 4 and 5 show and example of a pop-up window 262 displaying the alert over the POS application GUI 260 in response to the command received from the scanning device 100 by the virtual display application 214.

The scanning device 100 may include its own GTIN alert application 150 loaded in memory therein for execution by the processor. The GTIN alert application 150 may compare item reads vs. a database that may be stored locally (if memory footprint allows) or over a network to determine whether the alert should be sent to the virtual display application 214 of the POS system 210. The database may be transmitted with a defined protocol. For efficiency and quick response during a real-time transaction, a partial database or other local database may be downloaded periodically (e.g., each night) to the scanning device 100 retrieve or update recall information (e.g., health risk, mandatory recall, etc.) As a result, POS software modification may be avoided or very minimal for easy deployment (e.g., plug and play). In some embodiments, certain options may be configurable to permit the user (e.g., retailer) to select which level & region of recalls are to be retrieved.

Communication between the scanning device 100 and the POS system 210 may occur via one or more communication channels. In some embodiments, GTIN data and additional product information may be transmitted together over a common communication channel. In some embodiments, separate communication channels may be established via different ports such that GTIN data is provided to the POS application 212 via a first port, and additional product information is provided to the virtual display application 214 via a second port. Ports may be configured as USB, Ethernet, or other communication channels as desired.

As discussed above, alerts may be communicated to the user via the POS system 210, such as by generating a pop-up window over the POS application. This may be triggered by the scanning device 100 transmitting a special message (e.g., command, etc.) to the host over the host interface and/or by the scanning device 100 transmitting special label data to the host over the host interface.

In some embodiments, the scanning device 100 may also communicate the alert to the user via unique actions performed by the scanning device 100. For example, in some embodiments the scanning device 100 generating a unique audible message, such as a beep volume, unique beep frequency, unique beep pattern, unique sound pattern from a wave file or other sound representation. In some embodiments, the scanning device 100 producing a unique visual message, such as a unique hue or pattern of hues of an illumination source or pattern of illumination sources, unique flash pattern of an illumination source or pattern of illumination sources, a unique brightness of an illumination source or pattern of illumination sources. The illumination sources may include LEDs, Lasers, and/or other light sources. Any combination of such indications or alerts provided by the POS system 210 and/or the scanning device 100 are also contemplated.

Additional scanner configuration properties may include one or more of the following:
a. Configuration properties to enable/disable items, such as checking for expiration dates.
b. Configuration properties to define unique actions.
c. Some unique actions may be pre-defined.
d. Configuration properties to associate unique actions to specific results of label application data checks.
   i. The label application data checks could be checking for a range of data.
   ii. The label application data checks could be checking the current time/date against label application data based on time/date.
   iii. The label application data checks could be checking the current time/date against a range of time/date based on the label application data.
e. Script logic to load into the label formatting, indication, and transmission scripting engine(s).

In some embodiments, software modifications and improvements to the scanning device 100 may include one or more of the following:
a. Parsing of the GS1 2D label data to extract the application identifiers and their fields
b. Configurable properties
c. Support of a real-time clock
d. Support of the label application data checks (rules) that my start a unique action.
e. Real-time support to label formatting, indication, and transmission scripting engine(s).
f. Built-in parsing of the GS1 2D label data to label formatting, indication, and transmission scripting engine(s).
g. Access to unique actions to label formatting, indication, and transmission scripting engine(s).

With this information, a scanning device may be updated to generate unique actions for specific results of checks on GS1 label application data.

In some embodiments, the additional information obtained from GS1 Digital Link (e.g., 2D barcode) labels may also be recorded for an entire transaction and associated with a customer (e.g., loyalty account, credit card account, etc.) such that if a purchased product is later determined to be problematic (e.g., recalled), a system server may query all transactions involving such products (e.g., via batch/lot number) to identify the transactions and customers involved in purchasing such products. In the situation where a recalled product is found from querying the additional information recorded from prior transactions, a notification (e.g., text, email, push notification, phone call, etc.) may be generated to inform the customer and/or provide instructions for disposal or return of product, initiate refunds, and the like.

Unique actions may not be limited to just the product itself. Additional information may be communicated to the user about the transaction itself. For example, the user of a scanner may want to know if the 1D label, 2D label, or other label (e.g., digital watermark) was decoded and transmitted to the POS system. Unique indications may also be generated to differentiate the decoding and transmit of the 1D label, 2D label, and/or other labels (e.g., digital watermarks). Such unique indications may assist the user learn how to scan a product to read the desired label more quickly and efficiently. The retail store may want the 2D label to be decoded and transmitted whenever it is on a product. Retail stores may also have incentives for their cashiers to always read the 2D label when it is present. The special indication will enable the cashiers to know when they have read a 1D label versus a 2D label versus another label type. As a result, the scanning device may be configured to provide messages to the users (e.g., cashiers and/or self-checkout users) in situations where legacy POS systems do not support all of the possible data sources with digital link labels.

When a label (e.g., 1D, 2D, other) is decoded and transmitted, the appropriate indication may be used based on the configuration settings. Unique indications could be enabled/disabled through configuration properties. A single configuration property may be defined to enable unique indications for all GS1 digital link labels. The type of indication for the different labels and label types could be controlled through configuration properties.

Two additional examples are described below to illustrate how these embodiments may be implemented in POS applications:

In some embodiments, the scanning device may be configured to maintain a trained list of GTIN codes which are known to be Digital Link items. If such a GTIN is detected (e.g., from a 1D barcode), the scanning device may indicate to user that a Digital Link code (e.g., from a 2D barcode) exists and should also be scanned. In this example, the scanning device may read the 1D label first. The scanning device may determine that this GTIN should also include a Digital Link code. Within a predetermined time period (e.g., 1 second), the scanning device may recognize that the Digital Link code was not scanned and an alert may be generated to provide the indication to the user as discussed above. Such an indication, may include the scanning device triggering a .wav file to produce an audible message to the user such as “Please scan the 2D Bar Code on this item to confirm freshness.” Other alerts/indications may also be used to communicate this message to the user as discussed above, such as via triggering a pop-up window on the POS system, triggering other audible or visual alerts on the scanning device and/or the POS system.

In some embodiments, the scanning device may be configured to decode the freshness date or expiration date from the additional information embedded in the Digital Link label (e.g., 2D label). The date information from the Digital Link label may be compared to the current date maintained by the scanning device to then generate an indication to the user. In some embodiments, the scanning device may trigger a .wav file to produce an audible message to the user such as “Your item is expired. Please see store attendant for a fresh item.” Different messages may be triggered if other based on other situations determined by the date information relative to the current date. For example, if the date is within a good range, the scanning device may trigger a .wav file to indicate “Your item is fresh” or “Your item expires in x days” if the expiration date is coming up. Other alerts/indications may also be used to communicate this message to the user as discussed above, such as via triggering a pop-up window on the POS system, triggering other audible or visual alerts on the scanning device and/or the POS system.

The foregoing method descriptions and/or any process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be communicated (e.g., passed, forwarded, and/or transmitted) via any suitable means including memory sharing, message passing, token passing, network transmission, etc.

The actual software code or specialized control hardware used to implement these systems and methods is not limiting of the disclosure. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The previous description is of various preferred embodiments for implementing the disclosure, and the scope of the invention should not necessarily be limited by this description. The scope of the present invention is instead defined by the claims.

What is claimed:

1. A scanning device, comprising:
an imager configured to capture images of items passing through a field of view;
a memory having rules stored thereon associated with actions to be taken based on decoded GS1 label application data; and
a processor operably coupled to the imager and the memory, the processor configured to generate unique actions for specific results of checks on GS1 label application data decoded from a GS1 Digital Link label on the item.

2. The scanning device of claim 1, wherein the unique actions include the scanning device transmitting a special message to a host over a host interface.

3. The scanning device of claim 1, wherein the unique actions include the scanning device transmitting special label data to a host over a host interface.

4. The scanning device of claim 1, wherein the unique actions include the scanning device generating a unique audible message based on the GS1 label application data.

5. The scanning device of claim 4, wherein the unique audible message includes at least one of a unique beep volume, unique beep frequency, unique beep pattern, unique sound pattern from a wave file or other sound representation.

6. The scanning device of claim 1, wherein the unique actions include the scanning device producing a unique visual message based on the GS1 label application data.

7. The scanning device of claim 6, wherein the unique visual message includes at least one of a unique hue or pattern of hues of an illumination source or pattern of illumination sources, unique flash pattern of an illumination source or pattern of illumination sources, a unique brightness of an illumination source or pattern of illumination sources.

8. The scanning device of claim 1, wherein the processor configured to generate unique actions when a specific product is scanned to remind the user of a special action that is needed.

9. The scanning device of claim 1, wherein the processor configured to generate unique actions when a specific batch or lot number of a specific product is scanned to identify a recalled item.

10. The scanning device of claim 1, wherein the processor configured to generate unique actions when a product is scanned on or after the expiration date to prevent the item from being sold or cause the product to be sold at a reduced price.

11. The scanning device of claim 1, wherein the processor configured to generate unique actions when a product is scanned within a timeframe of the expiration date to indicate the product should be sold at a reduced in price.

12. The scanning device of claim 1, wherein the processor configured to generate unique actions when a specific serial number or range of serial numbers is scanned to identify a recalled item.

13. The scanning device of claim 1, wherein the processor configured to generate unique actions in response to a specific label type being decoded.

14. The scanning device of claim 1, wherein the processor configured to generate unique actions to inform a user that a specific label type has not yet been decoded.

15. The scanning device of claim 1, wherein the unique actions are based on configuration settings.

16. The scanning device of claim 1, wherein the configuration settings may be enabled or disabled by a user.

17. The scanning device of claim 1, wherein the unique actions include transmitting a command to a point-of-sale (POS) system over a first communication channel instructing the POS system to generate an alert based on the GS1 label application data.

18. The scanning device of claim 17, wherein the POS system includes a POS application for managing a transaction using GTINs received by the scanning device.

19. The scanning device of claim 17, wherein the POS system includes a virtual display application for managing the commands received by the scanning device based on the GS1 label application data, wherein the POS application and the virtual display application are independent from each other.

20. The scanning device of claim 19, wherein the virtual display application triggers a pop-up window over a GUI for the POS application in response to the command received by the scanning device.
